(19) United States
(12) Patent Application Publication
(10) Pub. No.: US 2014/0074431 A1
(43) Pub. Date: Mar. 13, 2014

(54) Wrist Pedometer Step Detection

(71) Applicant: Yash Rohit Modi, Foster City, CA (US)

(72) Inventor: Yash Rohit Modi, Foster City, CA (US)

(73) Assignee: APPLE INC., Cupertino, CA (US)

(21) Appl. No.: 13/608,214

(22) Filed: Sep. 10, 2012

(51) Int. Cl. G06F 15/00

(52) U.S. Cl. 702/160

(57) ABSTRACT

In some implementations, optimizations for detecting steps when a pedometer is worn at a user's wrist are described. In some implementations, a threshold crossing step detection method can be enhanced for wrist locations by counting the number of positive peaks between comparison threshold crossings, adjusting a minimum peak-to-peak threshold for qualifying threshold crossings, and inferring a second step based on the amount of time between threshold crossings. In some implementations, the pedometer can automatically determine that the pedometer is being worn on a user's wrist.

### TECHNICAL FIELD

The disclosure generally relates to pedometer step detection.

### BACKGROUND

A pedometer can be used to count steps and determine distance traveled by a user of the pedometer. Pedometers can be mechanical or digital. Digital pedometers can use built in motion sensor (e.g., accelerometers) to detect movement of the digital pedometer. When the digital pedometer is worn by a user, the signals received from the motion sensor can be analyzed to determine when a user takes a step. The algorithms for analyzing the signals can vary based on where on the user's body the pedometer is attached.

### SUMMARY

In some implementations, optimizations for detecting steps when a pedometer is worn at a user's wrist are described. In some implementations, a threshold crossing step detection method can be enhanced for wrist locations by counting the number of positive peaks between comparison threshold crossings, adjusting a minimum peak-to-peak threshold for qualifying threshold crossings, and inferring a second step based on the amount of time between threshold crossings. In some implementations, the pedometer can automatically determine that the pedometer is being worn on a user's wrist.

Particular implementations provide at least the following advantages: Users can receive accurate step counts when the pedometer is worn at the wrist. Distance estimation can be improved based on more accurate step counts. Users do not have to specify where the pedometer is being worn.

Details of one or more implementations are set forth in the accompanying drawings and the description below. Other features, aspects, and potential advantages will be apparent from the description and drawings, and from the claims.

### DESCRIPTION OF DRAWINGS

FIG. 1 is a graph representing the forces of gravity detected by a pedometer when walking or running when the pedometer is worn on the trunk of the user's body.

FIG. 2 is an illustration of a person using a wrist pedometer for step detection.

FIG. 3 is a graph of motion sensor data generated when the pedometer is worn at the user's wrist.

FIG. 4 is a block diagram of a pedometer configured to detect steps when worn at a user's wrist.

FIG. 5 is flow diagram of an example pedometer step detection process when the pedometer is worn at the wrist.

FIG. 6 is a block diagram of an example computing device that can implement the features and processes of FIGS. 1-5.

Like reference symbols in the various drawings indicate like elements.

### DETAILED DESCRIPTION

### Overview

Pedometers are typically attached to the trunk (e.g., waist, pant pocket, shirt pocket, etc.) of a user's body. Thus, the major forces typically detected by a pedometer are the forces associated with the steps that a user is taking when walking or running The magnitude of the forces detected by a pedometer (e.g., an accelerometer within the pedometer) include the force of gravity and those forces exerted by a user against the force of gravity. For example, when standing still the pedometer can detect 1G (1 times the force of gravity) exerted against the pedometer. When the user pushes off the ground to take a step, the pedometer can detect forces greater than 1G. When the user is between steps, the pedometer can detect forces less than 1G. By monitoring the forces detected by the pedometer and determining when the 1G threshold is crossed, the pedometer can detect when a step is taken by the user.

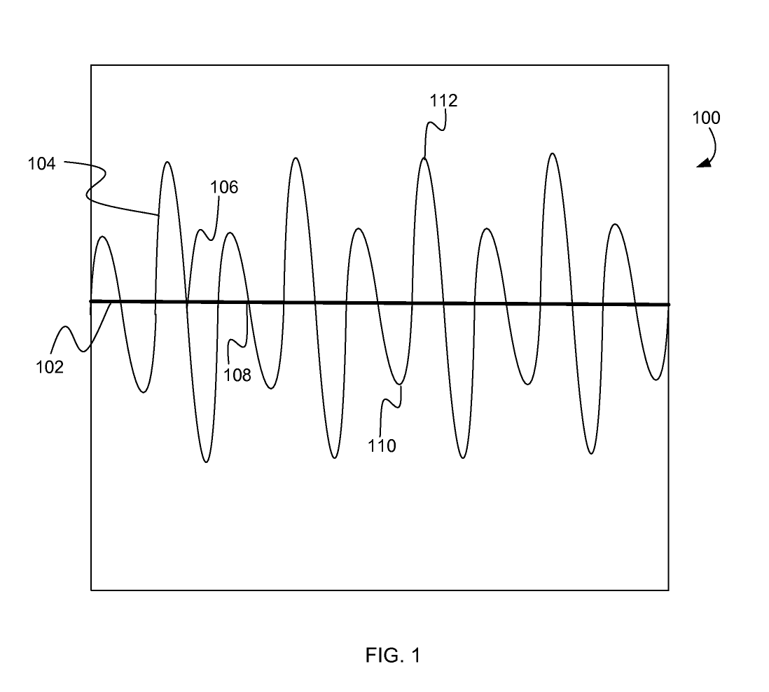

FIG. 1 is a graph 100 representing the forces of gravity detected by a pedometer when walking or running when the pedometer is worn on the trunk of the user's body. For example, line 102 represents a constant 1G force of gravity and is used as a comparison threshold for detecting steps taken by the user. Line 104 represents the force of gravity detected by the motion sensor as the user is walking or running A step can be detected when the motion sensor measurements represented by line 104 cross below the comparison threshold 102. For example, a step can be detected when the motion sensor measurements cross comparison threshold 102 at points 106 and 108 on a negative or downward slope of line 104 and a step count can be incremented for each comparison threshold crossing.

However, the threshold crossing algorithm described above does not accurately count steps for all pedometer uses. For example, a constant comparison threshold does not work well for detecting steps when a user is running as some steps can be lost due to uneven steps or where the pedometer is worn (e.g., waist, pocket, etc). Thus, an adaptive comparison threshold (e.g., moving average threshold) can be implemented, as described in patent application Ser. No. 13/251,142 entitled “Techniques for Improved Pedometer Readings” which is incorporated herein by reference. For example, the moving average threshold adjusts the comparison threshold according to the average of the detected acceleration. To ensure that extra steps are not counted (e.g., steps that may be attributed to noise), a peak-to-peak (e.g., negative peak 110 to positive peak 112) swing threshold (e.g., 0.2 g) can be used to identify threshold crossings attributable to steps rather than noise. For example, comparison threshold crossings having peak-to-peak swings of 0.2 or greater are attributed to steps while comparison threshold crossings having peak-to-peak swings of less than 0.2 g are attributed to noise and not counted as a step.

Moreover, frequency analysis can be performed to determine whether the detected steps are walking steps or running steps, as described in patent application Ser. No. 13/251,136 entitled “Techniques for Improved Pedometer Readings” which is incorporated herein by reference in its entirety. For example, frequency analysis can be performed on motion sensor data to determine a dominant frequency. If the dominant frequency is less than 2.5 Hz, then it can be determined that the user is walking If the dominant frequency is greater than 2.5 Hz, then it can be determined that the user is running. The dominant frequency can also be used to select one of several frequency band filters. For example, if the dominant frequency is determined to be 2.0 Hz, then a frequency band filter of 1.5-2.5 Hz can be selected to filter the sensor data. Filtering the sensor data allows the sensor data to be smoothed for better analysis and step detection.

However, while the above algorithms provide for improvements in step detection when the pedometer is worn on the user's trunk, they fail to accurately detect and count steps when the pedometer is worn at the user's wrist. For example, when the pedometer is worn at the wrist the acceleration forces associated with the swinging of the user's arm can interfere or mix with the acceleration forces associated with steps taken by the user. The mixing of the arm forces with the step forces can cause the above step detection algorithms to miss some steps resulting in an inaccurate step count.

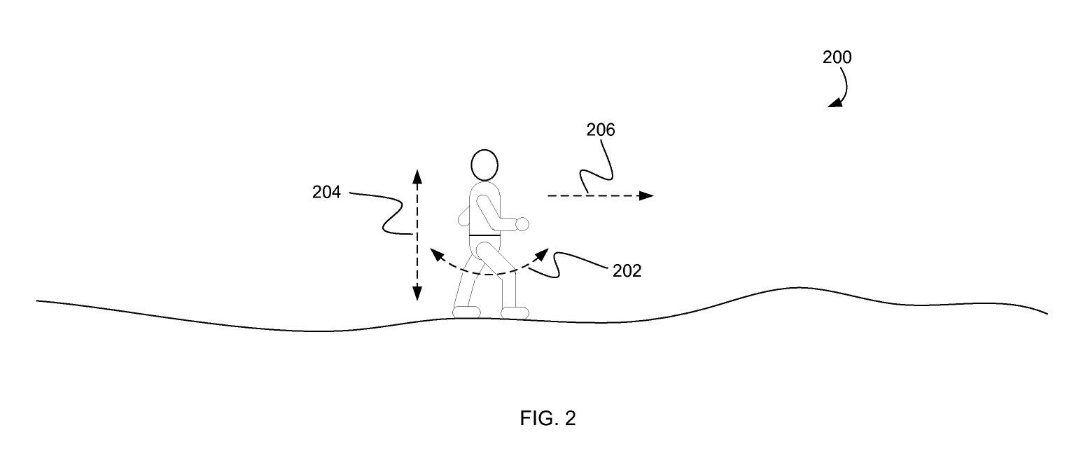

FIG. 2 is an illustration 200 of a person using a wrist pedometer for step detection. For example, a pedometer worn on a user's wrists is subject to the forces generated by the swinging of the user's arm 202 as the user walks or runs in addition to the forces generated when the user pushes off the ground to take a step (204, 206). Thus, the swinging of the user's arm and the swinging of the pedometer makes step detection more difficult than when the pedometer is attached to the user's trunk. For example, as the user is walking, the user will be swinging the user's arms and generating forces that get detected by the pedometer. The forces generated by swinging the user's arms can counteract or mix with the forces generated by taking a step. For example, the acceleration of the user's arm can be opposite of the acceleration of the user's step off the ground resulting in the pedometer failing to detect and count the step, as described further below.

### Determining Steps—Positive Peak Counting

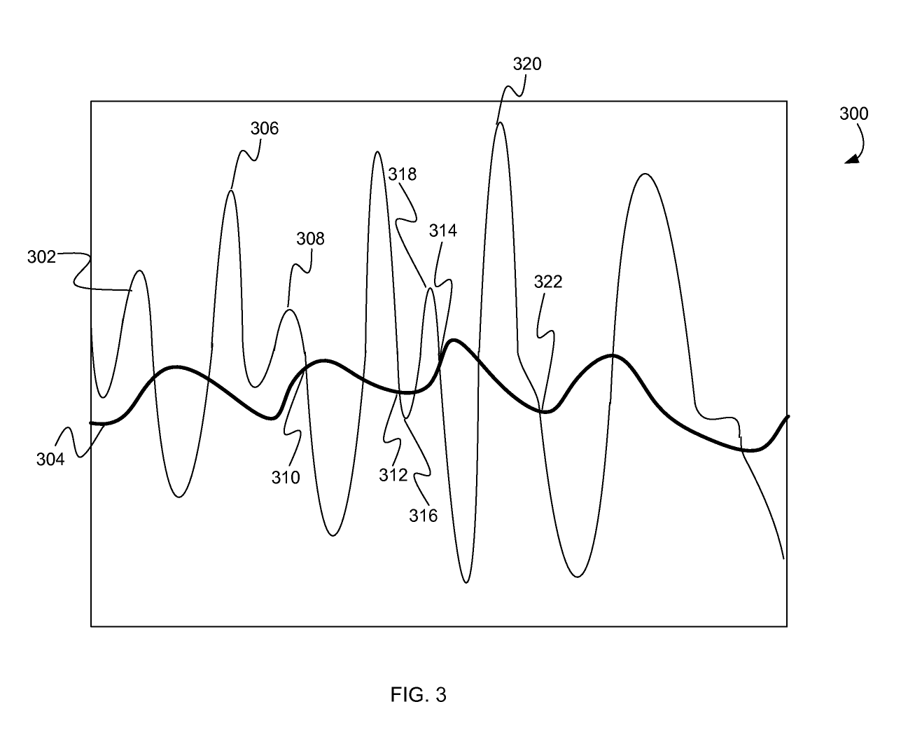

FIG. 3 is a graph 300 of motion sensor data generated when the pedometer is worn at the user's wrist. Graph 300 includes line 302 representing sensor magnitude measurements and line 304 representing the moving average comparison threshold. Graph 300 clearly shows that wearing the pedometer on the wrist causes confusion or mixing of the step and arm swing forces. Moreover, because the arm swing forces interfere with the step forces, if only comparison threshold crossings are considered when counting steps, steps will be missed. For example, peak 306 corresponds to a left step and peak 308 corresponds to a right step, however, there is only one threshold crossing 310 associated with these two steps. Thus, in some implementations, steps can be determined by counting the number of positive peaks (e.g., above the comparison threshold) between comparison threshold crossings.

### Peak-to-Peak Threshold Adjustment

Moreover, some steps can be missed when the swinging of the user's arm prevents a threshold crossing from being counted as a step due to failing to satisfy the peak-to-peak threshold criteria. As described above, in some implementations, comparison threshold crossings will be counted as a step only if the peak-to-peak (negative peak to positive peak) swing is greater than a threshold value (e.g., 0.2G by default). However, when the pedometer is worn at the wrist, the peak-to-peak threshold value may not be met on the alternate step. For example, the 0.2G threshold value may be met on the first step but not on the second (e.g., alternate) step due to mixing arm movement with the user's step. For example, graph 300 illustrates threshold crossing 312 and threshold crossing 314. However, threshold crossing 314 may not be counted as a step because the peak-to-peak swing between negative peak 316 and positive peak 318 is not greater than 0.2G. Thus, in some implementations, the peak-to-peak threshold value can be adjusted (e.g, reduced to 0.1G) for the second or alternate step so that threshold crossing 314 can be counted as a step.

### Inferring Step Based on Time

In some instances, graph 300 can display one peak between comparison threshold crossings even though the user has taken two steps. For example, peak 320 is the only peak between threshold crossing 314 and 322 even though the user has taken two steps between threshold crossing 314 and 322. In this case, the amount of time that has passed between threshold crossings can be used to infer a second step. For example, if the time between threshold crossing 314 and 322 is greater than 0.6 seconds (e.g., the shortest amount of time to take two walking steps), then a second step can be inferred.

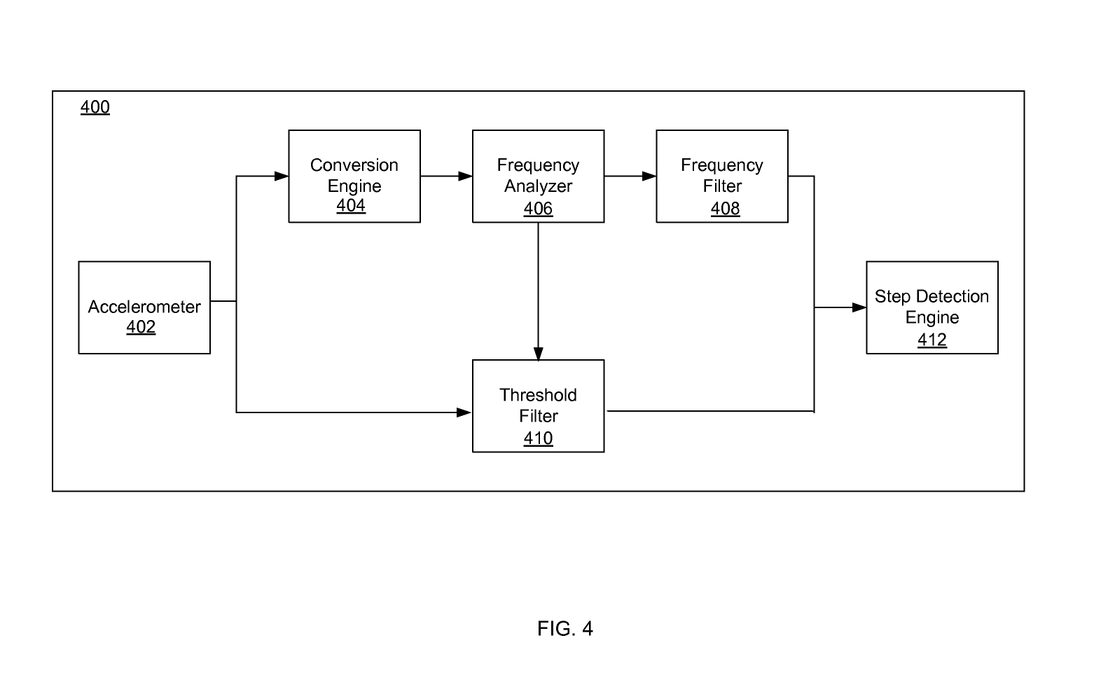

FIG. 4 is a block diagram of a pedometer 400 configured to detect steps when worn at a user's wrist. For example, pedometer 400 can be configured to perform the positive peak counting, peak-to-peak threshold adjustment and step inference described above. Pedometer 400 can include a motion sensor 402 (e.g., an accelerometer). For example, motion sensor 402 can detect and/or measure motion in three dimensions (e.g., x, y and z dimensions) as the pedometer is swung on the user's arm and/or as the user is walking, running, etc. Conversion engine 404 can convert the three dimensional motion measurements into magnitude measurements by calculating the square root of the sum of the squares of the motion measurements (e.g., the square root of x²+y²+z²).

In some implementations, frequency analyzer 406 can analyze the magnitude measurements to determine a dominant frequency, as described in patent application Ser, No. 13/251,136 entitled “Techniques for Improved Pedometer Readings” which is incorporated herein by reference in its entirety. For example, the dominant frequency can correspond to steps that the user takes while the user is wearing the pedometer. In some implementations, frequency analyzer 406 can perform fast Fourier transform (FFT), or any other suitable algorithm for determining the dominant frequency in the magnitude measurements. In some implementations, frequency analyzer 406 can analyze the magnitude measurements to determine an average acceleration value of the dominant frequency, as described in patent application Ser. No. 13/251,142 entitled “Techniques for Improved Pedometer Readings” incorporated herein by reference. For example, the average acceleration value can be used by threshold filter 410 to determine a moving threshold (e.g., comparison threshold) for detecting steps, as discussed above.

In some implementations, frequency filter 408 can adaptively filter the magnitude measurements based on the dominant frequency determined by frequency analyzer 406. For example, if the dominant frequency changes (e.g., the user switches from walking to running), the frequency filter 408 can identify the change in dominant frequency and filter the magnitude measurements to exclude signals that are not within a range of frequencies (e.g., frequency band) associated with the dominant frequency. Adaptive frequency filters are disclosed in greater detail in patent application Ser. No. 13/251,136 entitled “Techniques for Improved Pedometer Readings” which is incorporated herein by reference in its entirety.

In some implementations, threshold filter 410 can receive the average acceleration value of the dominant frequency from frequency analyzer 406. The average acceleration value can be used as a threshold value (e.g., comparison threshold) for step detection. For example, when the magnitude measurements cross the comparison threshold one or more steps can be detected. In some implementations, the threshold value is adaptive. For example, as new motion sensor measurements are received, the threshold value can be adjusted for changes in the dominant frequency and the average acceleration value of the dominant frequency. Techniques for using moving average threshold values for step detection are disclosed in greater detail in patent application Ser. No. 13/251,142 entitled “Techniques for Improved Pedometer Readings” which is incorporated herein by reference.

In some implementations, pedometer 400 can include step detection engine 412. Step detection engine 412 can receive data from frequency filter 402 and threshold filter 410. Frequency filter 402 can provide magnitude measurements that correspond to the dominant frequency. Threshold filter 410 can provide the step detection threshold value. For example, when a magnitude measurement crosses the step detection threshold, one or more steps can be detected.

In some implementations, step detection engine 412 can detect steps by counting positive peaks between comparison threshold crossings. For example, if the amount of time between comparison threshold crossings is greater than the fastest walking rate for two steps (e.g., 0.6 seconds), then step detection engine can determine if two positive peaks can be observed between the comparison threshold crossings. Thus, if the time between crossings is greater than 0.6 seconds and two positive peaks can be observed in the magnitude measurements, then two steps will be counted. If the time between comparison threshold crossings is less than 0.6 seconds, then it can be determined that the user is running and only one step will be counted.

In some implementations, step detection engine 412 can detect steps by reducing the peak-to-peak swing threshold value for alternate steps. For example, some comparison threshold crossings will not be counted as a step if the peak-to-peak swing before the comparison threshold crossing does not exceed a default value (e.g., 0.2G). However, when the pedometer is worn at the wrist, the peak-to-peak swing threshold can be reduced (e.g., to 0.1G) when the previous peak-to-peak swing exceeds the default threshold value (e.g., 0.2G). Thus, an alternate step that would not have been counted as a step because of an arm swing that would reduce the peak-to-peak swing to less than 0.2G can be correctly identified and counted as a step.

In some implementations, step detection engine 412 can infer a step based on the amount of time between comparison threshold crossings. For example, if the amount of time between comparison threshold crossings is greater than the fastest walking rate for two steps (e.g., 0.6 seconds) but only one positive peak is observed between comparison threshold crossings, then a second step can be inferred based on the amount of time between comparison threshold crossings.

### Automatic Wrist Classification

In some implementations, the wrist optimizations described above are only utilized when the pedometer determines that it is being worn on a user's wrist. In some implementations, the user can specify a wrist location by providing input to or selecting one or more options through a user interface of the pedometer.

In some implementations, the pedometer can be configured to automatically detect that the pedometer is being worn on the user's wrist. For example, when the pedometer is worn at the wrist, the dominant frequency (e.g., the fast Fourier transform (FFT) derived frequency) of the motion sensor data is about half of the actual step frequency. The actual step frequency can be thought of as a cadence where the cadence is defined as the number of steps divided by the time. For example, if the cadence is greater than 2.5 the user is running If the cadence is less than 2.5 then the user is walking In some implementations, the ratio of cadence to FFT derived frequency can be used to determine whether the pedometer is worn at the wrist or at the waist. For example, if the ratio of cadence to FFT derived frequency equals one (1), then the pedometer is worn at the waist. If the ratio of cadence to FFT derived frequency is less than one (1), then the pedometer is worn at the wrist.

In some implementations, when the user is running (e.g., FFT frequency or cadence is greater than 2.5), the pedometer can determine that the pedometer is worn at a wrist location based on the cadence to FFT frequency ratio described above and the comparison threshold value (e.g., moving average). For example, the comparison threshold value for wrist locations will be larger than the comparison threshold value for waist locations because of the movement of the user's arm. In some implementations, if the pedometer cannot determine that the pedometer is worn at the wrist, then waist location algorithms can be used instead of the wrist location algorithms described above.

### Example Process

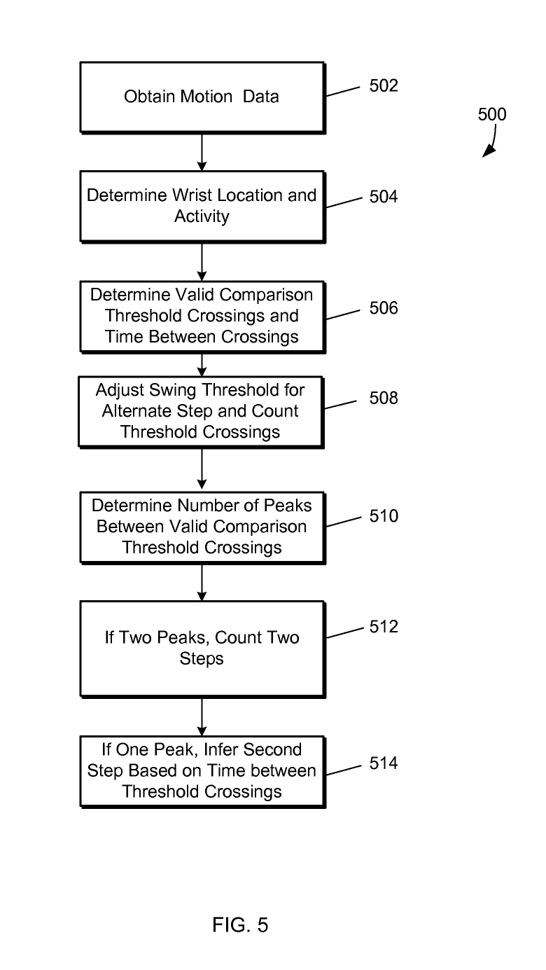

FIG. 5 is flow diagram of an example pedometer step detection process 500 when the pedometer is worn at the wrist. At step 502, motion data is obtained. For example, the motion data can be obtained from a motion sensor (e.g., an accelerometer). The motion data can be converted into acceleration magnitude values and analyzed to determine the dominant frequency. The dominant frequency can be used to select a band filter for filtering (e.g., smoothing) the sensor magnitude data. The motion data can be analyzed to determine a moving average comparison threshold for determining steps. For example, a moving average of acceleration magnitudes for the dominant frequency can be calculated. The moving average can be used as an adjustable comparison threshold for determining steps. For example, when the acceleration magnitude value crosses below the adjustable comparison threshold, a step can be counted, as described above.

At step 504, the pedometer can automatically determine that the pedometer is being worn at the wrist of the user and determine the activity of the user. For example, if the dominant frequency is above a run threshold frequency (e.g., 2.5 Hz), then the user is running If the dominant frequency is below the run threshold frequency, the user is walking The run threshold frequency can be used for both wrist and trunk locations because the dominant frequency is effected little by the swing of the users arm when the user is running

When the user is walking, the pedometer can determine that the pedometer is being worn on the user's wrist by comparing the FFT derived dominant frequency to cadence. For example, if the cadence (e.g., number of steps/time) for the user's walk is 2.0 Hz and the FFT derived dominant frequency is 1.0 Hz, then the pedometer can determine that the pedometer is being worn at the wrist because the FFT derived dominant frequency is normally about half of the walking cadence. Thus, the ratio of walking cadence to FFT derived dominant frequency can be used to determine that the pedometer is being worn at the wrist when the user is walking For example, if the cadence to FFT frequency (e.g., cadence/FFT frequency) is less than one (1), then the pedometer is being worn at the wrist. If the cadence to FFT frequency is about equal to (1), then the pedometer is being worn at a trunk or waist location.

When the user is running, the pedometer can determine that the pedometer is being worn on the user's wrist based on the moving average comparison threshold. For example, when worn on the wrist, the pedometer will generate a higher moving average comparison threshold than when the pedometer is being worn on the trunk or waist. The combination of higher moving average comparison threshold and cadence to FFT derived frequency ratio (as described above) can be used to determine that the user is wearing the pedometer at the wrist while running

At step 506, the acceleration magnitude data can be analyzed to determine valid comparison threshold crossings and the amount of time between crossings. For example, a valid comparison threshold crossing can be identified if the acceleration magnitude data crosses the comparison threshold and the previous peak-to-peak swing is greater than the default peak-to-peak threshold value (e.g., 0.2G). Each valid comparison threshold crossing can be identified as a step and added to the step count. When two adjacent valid comparison threshold crossings are identified, the pedometer can determine the amount of time between crossings. If the amount of time between crossings is greater than the fastest time it takes to take two steps (e.g., 0.6 seconds), then the wrist/walk optimizations of steps 508-514 can be performed.

At step 508, the peak-to-peak swing threshold for the alternate step can be adjusted and the threshold crossing for the alternate step counted. For example, if there is an invalid comparison threshold crossing between the two valid comparison threshold crossings described above the peak-to-peak swing threshold can be adjusted (e.g., from 0.2G to 0.1G). The peak-to-peak swing immediately before the invalid comparison threshold crossing can be compared to the adjusted peak-to-peak swing threshold to determine if the invalid comparison threshold crossing should be counted as a step. For example, if the peak-to-peak swing is greater than or equal to the adjusted peak-to-peak threshold value (e.g., 0.1G), then the invalid comparison threshold crossing can be counted as a step in addition to the steps attributed to the valid comparison threshold crossings.

At step 510, the pedometer can determine the number of positive peaks between valid comparison threshold crossings. For example, when worn at the waist, the pedometer will typically observe one positive peak per comparison threshold crossing. However, when worn at the wrist, the pedometer will sometimes register two positive peaks for one threshold crossing. If the time between valid threshold crossings is greater than the time it takes to take two walking steps (e.g., 0.6 seconds), then steps can be identified by counting the number of positive peaks between valid comparison threshold crossings. Thus, if there is one comparison threshold crossing but two peaks, then two steps can be counted instead of just the one attributed to the valid comparison threshold crossing, at step 512.

At step 514, a second step can be inferred based on the time between threshold crossings. For example, when the pedometer is worn at the user's wrist, detected the wrist motion can mix with the detected step motion and prevent a second step peak from being detected. In this case, a second step can be inferred based on the amount of time between valid comparison threshold crossings. For example, if the user is walking and taking two steps every 0.8 seconds and 0.8 seconds has passed between valid comparison threshold crossings, then a second step can be inferred based on the user's walking rate. Thus, even if a step is missed because a second peak is not detected, based on heuristics, it is possible to predict or infer the occurrence of the second step and add the second step to the step count.

Thus, the process described above allows for improving the accuracy of the pedometer's step count by identifying and counting steps that would be missed using previous threshold crossing algorithms. Moreover, the accuracy of distance measurements can be improved as pedometer distance calculations are, in some implementations, a function of the number of steps and stride length.

### Example System Architecture

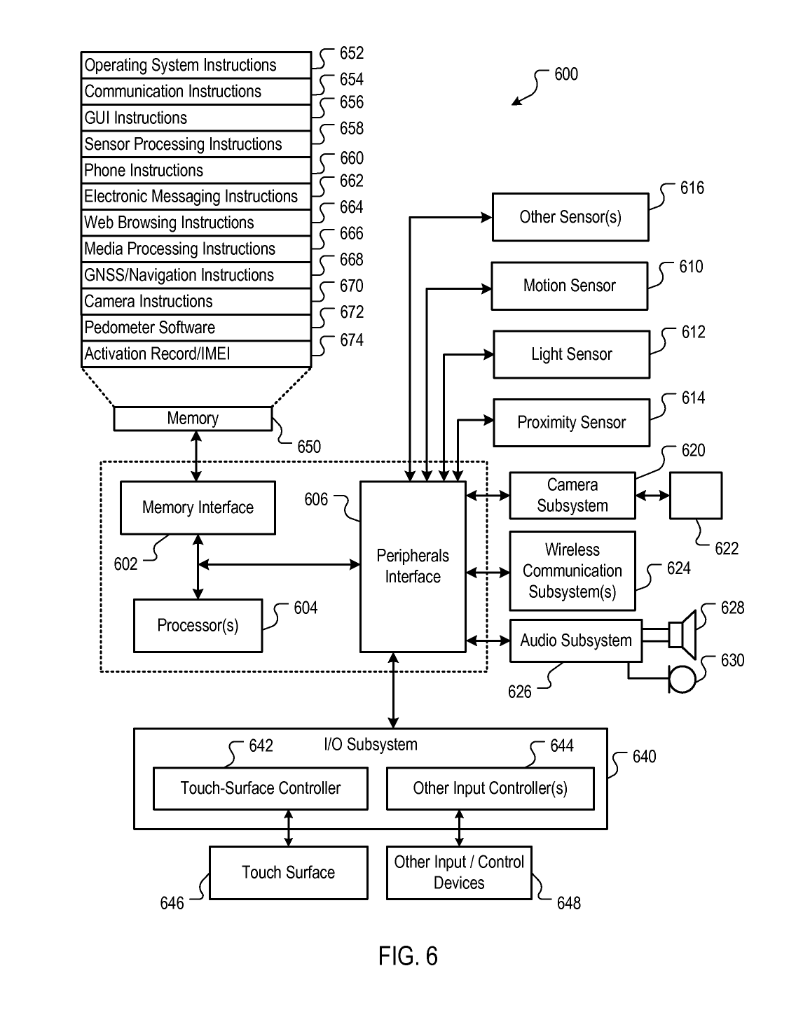

FIG. 6 is a block diagram of an example computing device 600 that can implement the features and processes of FIGS. 1-5. The computing device 600 can correspond to pedometer 400 of FIG. 4, for example. The computing device 600 can include a memory interface 602, one or more data processors, image processors and/or central processing units 604, and a peripherals interface 606. The memory interface 602, the one or more processors 604 and/or the peripherals interface 606 can be separate components or can be integrated in one or more integrated circuits. The various components in the computing device 600 can be coupled by one or more communication buses or signal lines.

Sensors, devices, and subsystems can be coupled to the peripherals interface 606 to facilitate multiple functionalities. For example, a motion sensor 610, a light sensor 612, and a proximity sensor 614 can be coupled to the peripherals interface 606 to facilitate orientation, lighting, and proximity functions. Other sensors 616 can also be connected to the peripherals interface 606, such as a global navigation satellite system (GNSS) (e.g., GPS receiver), a temperature sensor, a biometric sensor, or other sensing device, to facilitate related functionalities.

A camera subsystem 620 and an optical sensor 622, e.g., a charged coupled device (CCD) or a complementary metal-oxide semiconductor (CMOS) optical sensor, can be utilized to facilitate camera functions, such as recording photographs and video clips. The camera subsystem 620 and the optical sensor 622 can be used to collect images of a user to be used during authentication of a user, e.g., by performing facial recognition analysis.

Communication functions can be facilitated through one or more wireless communication subsystems 624, which can include radio frequency receivers and transmitters and/or optical (e.g., infrared) receivers and transmitters. The specific design and implementation of the communication subsystem 624 can depend on the communication network(s) over which the computing device 600 is intended to operate. For example, the computing device 600 can include communication subsystems 624 designed to operate over a GSM network, a GPRS network, an EDGE network, a Wi-Fi or WiMax network, and a Bluetooth™ network. In particular, the wireless communication subsystems 624 can include hosting protocols such that the device 100 can be configured as a base station for other wireless devices.

An audio subsystem 626 can be coupled to a speaker 628 and a microphone 630 to facilitate voice-enabled functions, such as speaker recognition, voice replication, digital recording, and telephony functions. The audio subsystem 626 can be configured to facilitate processing voice commands, voiceprinting and voice authentication, as described above with reference to FIGS. 1-5.

The I/O subsystem 640 can include a touch-surface controller 642 and/or other input controller(s) 644. The touch-surface controller 642 can be coupled to a touch surface 646. The touch surface 646 and touch-surface controller 642 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch surface 646.

The other input controller(s) 644 can be coupled to other input/control devices 648, such as one or more buttons, rocker switches, thumb-wheel, infrared port, USB port, and/or a pointer device such as a stylus. The one or more buttons (not shown) can include an up/down button for volume control of the speaker 628 and/or the microphone 630.

In one implementation, a pressing of the button for a first duration can disengage a lock of the touch surface 646; and a pressing of the button for a second duration that is longer than the first duration can turn power to the computing device 600 on or off. Pressing the button for a third duration can activate a voice control, or voice command, module that enables the user to speak commands into the microphone 630 to cause the device to execute the spoken command. The user can customize a functionality of one or more of the buttons. The touch surface 646 can, for example, also be used to implement virtual or soft buttons and/or a keyboard.

In some implementations, the computing device 600 can present recorded audio and/or video files, such as MP3, AAC, and MPEG files. In some implementations, the computing device 600 can include the functionality of an MP3 player, such as an iPod™. The computing device 600 can, therefore, include a 36-pin connector that is compatible with the iPod. Other input/output and control devices can also be used.

The memory interface 602 can be coupled to memory 650. The memory 650 can include high-speed random access memory and/or non-volatile memory, such as one or more magnetic disk storage devices, one or more optical storage devices, and/or flash memory (e.g., NAND, NOR). The memory 650 can store an operating system 652, such as Darwin, RTXC, LINUX, UNIX, OS X, WINDOWS, or an embedded operating system such as VxWorks.

The operating system 652 can include instructions for handling basic system services and for performing hardware dependent tasks. In some implementations, the operating system 652 can be a kernel (e.g., UNIX kernel). In some implementations, the operating system 652 can include instructions for performing voice authentication. For example, operating system 652 can implement one or more of the pedometer step counting features as described with reference to FIGS. 1-5.

The memory 650 can also store communication instructions 654 to facilitate communicating with one or more additional devices, one or more computers and/or one or more servers. The memory 650 can include graphical user interface instructions 656 to facilitate graphic user interface processing; sensor processing instructions 658 to facilitate sensor-related processing and functions; phone instructions 660 to facilitate phone-related processes and functions; electronic messaging instructions 662 to facilitate electronic-messaging related processes and functions; web browsing instructions 664 to facilitate web browsing-related processes and functions; media processing instructions 666 to facilitate media processing-related processes and functions; GNSS/Navigation instructions 668 to facilitate GNSS and navigation-related processes and instructions; and/or camera instructions 670 to facilitate camera-related processes and functions.

The memory 650 can store other software instructions 672 to facilitate other processes and functions, such as the pedometer step counting processes and functions as described with reference to FIGS. 1-5. For example, the software instructions can include instructions for counting steps the user takes when the pedometer is worn on the wrist.

The memory 650 can also store other software instructions (not shown), such as web video instructions to facilitate web video-related processes and functions; and/or web shopping instructions to facilitate web shopping-related processes and functions. In some implementations, the media processing instructions 666 are divided into audio processing instructions and video processing instructions to facilitate audio processing-related processes and functions and video processing-related processes and functions, respectively. An activation record and International Mobile Equipment Identity (IMEI) 674 or similar hardware identifier can also be stored in memory 650.

Each of the above identified instructions and applications can correspond to a set of instructions for performing one or more functions described above. These instructions need not be implemented as separate software programs, procedures, or modules. The memory 650 can include additional instructions or fewer instructions. Furthermore, various functions of the computing device 600 can be implemented in hardware and/or in software, including in one or more signal processing and/or application specific integrated circuits.

What is claimed is:

1. A method for counting steps at a mobile device, the method comprising:
obtaining motion data at a mobile device;
based on the motion data, determining a comparison threshold;
determining a first valid comparison threshold crossing;
determining a second valid comparison threshold crossing, where each valid comparison threshold crossing corresponds to a step and each step is added to a step count;
determining a time between the first valid comparison threshold crossing and the second valid comparison threshold crossing;
determining a missing step between the first valid comparison threshold crossing and the second valid comparison threshold crossing when the time is greater than an amount of time required to take two walking steps; and
adding the missing step to the step count.

2. The method of claim 1, wherein the first and second valid comparison threshold crossings are determined based on a default peak-to-peak swing threshold value.

3. The method of claim 1, wherein determining a missing step comprises adjusting the peak-to-peak threshold value and identifying a comparison threshold crossing that is greater than or equal to the peak-to-peak threshold value.

4. The method of claim 1, wherein determining a missing step comprises counting the number of positive peaks between valid comparison threshold crossings and adding a step to the step count when the number of positive peaks between valid comparison threshold crossings is greater than one.

5. The method of claim 1, wherein determining a missing step comprises inferring a second step when the time between valid comparison threshold crossings is greater than the amount of time required to take two walking steps.

6. The method of claim 1, wherein obtaining motion data comprises receiving data from an accelerometer on the mobile device.

7. A non-transitory computer-readable medium including one or more sequences of instructions which, when executed by one or more processors, causes:
obtaining motion data at a mobile device;
based on the motion data, determining a comparison threshold;
determining a first valid comparison threshold crossing;
determining a second valid comparison threshold crossing, where each valid comparison threshold crossing corresponds to a step and each step is added to a step count;
determining a time between the first valid comparison threshold crossing and the second valid comparison threshold crossing;
determining a missing step between the first valid comparison threshold crossing and the second valid comparison threshold crossing when the time is greater than an amount of time required to take two walking steps; and
adding the missing step to the step count.

8. The non-transitory computer-readable medium of claim 7, wherein the first and second valid comparison threshold crossings are determined based on a default peak-to-peak swing threshold value.

9. The non-transitory computer-readable medium of claim 7, wherein the instructions that cause determining a missing step comprise instructions that cause adjusting the peak-to-peak threshold value and identifying a comparison threshold crossing that is greater than or equal to the peak-to-peak threshold value.

10. The non-transitory computer-readable medium of claim 7, wherein the instructions that cause determining a missing step comprise instructions that cause counting the number of positive peaks between valid comparison threshold crossings and adding a step to the step count when the number of positive peaks between valid comparison threshold crossings is greater than one.

11. The non-transitory computer-readable medium of claim 7, wherein to instructions that cause determining a missing step comprise instructions that cause inferring a second step when the time between valid comparison threshold crossings is greater than the amount of time required to take two walking steps.

12. The non-transitory computer-readable medium of claim 7, wherein the instructions that cause obtaining motion data comprise instructions that cause receiving data from an accelerometer on the mobile device.

13. A system comprising:
one or more processors; and
a non-transitory computer-readable medium including one or more sequences of instructions which, when executed by the one or more processors, causes:
obtaining motion data at a mobile device;
based on the motion data, determining a comparison threshold;
determining a first valid comparison threshold crossing;
determining a second valid comparison threshold crossing, where each valid comparison threshold crossing corresponds to a step and each step is added to a step count;
determining a time between the first valid comparison threshold crossing and the second valid comparison threshold crossing;
determining a missing step between the first valid comparison threshold crossing and the second valid comparison threshold crossing when the time is greater than an amount of time required to take two walking steps; and
adding the missing step to the step count.

14. The system of claim 13, wherein the first and second valid comparison threshold crossings are determined based on a default peak-to-peak swing threshold value.

15. The system of claim 13, wherein the instructions that cause determining a missing step comprise instructions that cause adjusting the peak-to-peak threshold value and identifying a comparison threshold crossing that is greater than or equal to the peak-to-peak threshold value.

16. The system of claim 13, wherein the instructions that cause determining a missing step comprise instructions that cause counting the number of positive peaks between valid comparison threshold crossings and adding a step to the step count when the number of positive peaks between valid comparison threshold crossings is greater than one.

17. The system of claim 13, wherein to instructions that cause determining a missing step comprise instructions that cause inferring a second step when the time between valid comparison threshold crossings is greater than the amount of time required to take two walking steps.

18. The system of claim 13, wherein the instructions that cause obtaining motion data comprise instructions that cause receiving data from an accelerometer on the mobile device.
